(19) United States
(12) Patent Application Publication
(10) Pub. No.: US 2007/0144688 A1
(43) Pub. Date: Jun. 28, 2007

(54) Magnetically Adhering Automobile Window Bug Screen

(76) Inventor: Jeffrey John Grat, Alexandria, VA (US)

Correspondence Address: JEFFREY FURR, 253 N. MAIN STREET, JOHNSTOWN, OH, 43031, US

(21) Appl. No.: 11/419,760

(22) Filed: May 23, 2006

Related U.S. Application Data
(60) Provisional application No. 60/754,021, filed on Dec. 27, 2005.

(51) Int. Cl. B60J 1/20

(52) U.S. Cl. 160/370.21

(57) ABSTRACT

The current invention is an automobile bug screen that has a magnetically adhering assembly. The automobile bug screen consists of a portion of netting that is affixed to a border or “frame”. The frame is constructed of canvas, nylon or other sturdy material. This material is folded over the edge of the netting and sewn to create a seam and thereby affix the netting. Into this frame are inserted, at equal distances, are a plurality of ¾ inches or ⅝ iches craft magnets. The frame is sewn so as to encase each magnet in a separate pocket, thereby isolating it to its specific area in the frame. The screen is then placed over the exterior of the automobile window. The magnets adhere to the vehicle creating a bug proof barrier. The screen can be created to match any automobile passenger window size.

### CROSS REFERENCE TO RELATED APPLICATIONS

This application claims the Priority Date of Provisional Application 60/754,021 filed Dec. 27, 2005.

### BACKGROUND OF THE INVENTION

This invention relates generally to an automobile bug screen and more particularly one that is magnetically adhering.

### BACKGROUND

The use of bug deflectors is known in the prior art. Bug deflectors help to allow ventilation through open windows to allow ventilation of the parked vehicle while camping or at rest.

### PRIOR ART

U.S. Pat. No. 4,398,586 is for a Demountable vehicle window screen but it is made of a rigid design which is affixed a screen via wedging it against the frame of the car door. U.S. Pat. No. 4,463,790 is for a Flexible automobile screen but it is made of a roll and is difficult to use.

U.S. Design Pat. D487,240 is for a Automobile window screen which is rigid in design, not flexible or easy to use.

There is still room for improvement in the art.

### SUMMARY OF INVENTION

The current invention is an automobile bug screen that has a magnetically adhering assembly. The automobile bug screen consists of a portion of mosquito prohibitive netting that is affixed to a border or “frame”. The frame is constructed of canvas, nylon or other sturdy material. This material is folded over the edge of the netting and sewn to create a seam and thereby affix the netting. Into this frame are inserted, at equal distances, are a plurality of ¾ inch or ⅝ inch craft magnets. The frame is sewn so as to encase each magnet in a separate pocket, thereby isolating it to its specific area in the frame. The screen is then placed over the exterior of the automobile window. The magnets adhere to the vehicle creating a bug proof barrier to allow the ventenlation of the auto through open windows while the car is park or for camping. The screen can be created to match any automobile passenger window size.

### BRIEF DESCRIPTION OF DRAWINGS

Without restricting the full scope of this invention, the preferred form of this invention is illustrated in the following drawings:

FIG. 1 shows the bug screen;

FIG. 2 displays how the magnets are attached to the device; and

FIG. 3 displays the bug screen on a vehicle.

### DETAILED DESCRIPTION

The following description of a bug screen is demonstrative in nature and is not intended to limit the scope of the invention or its application of uses.

The current invention is a bug screen that allows the ventenlation of the auto through open windows while the vehicle is park or for camping

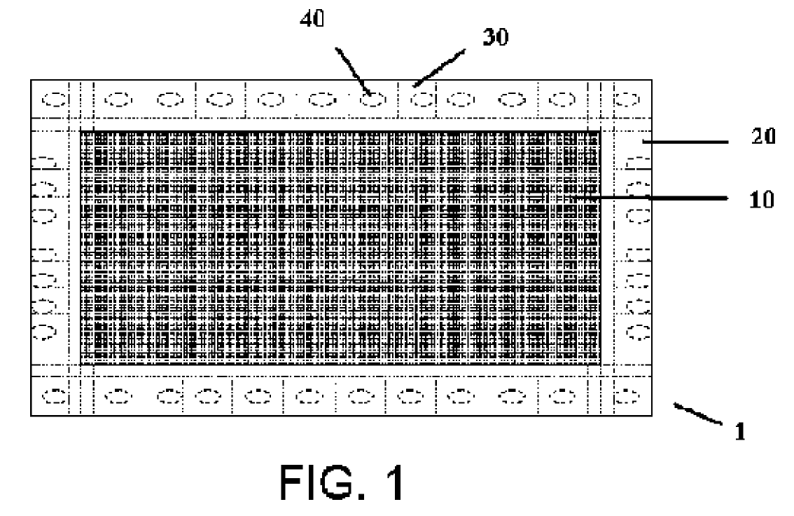

The screen assembly 1 that is shown in FIGS. 1, 2 and 3 has a prohibitive netting 10, which is made out of mosquito netting in the preferred embodiment. The prohibitive netting 10 is attached to a border which is called a “frame” 20.

The frame 20 is constructed of canvas, nylon or other sturdy material. This material is folded over the edge of the netting 10 and is affixed to the netting 10. In the preferred embodiment, the frame is sewn to create a seam.

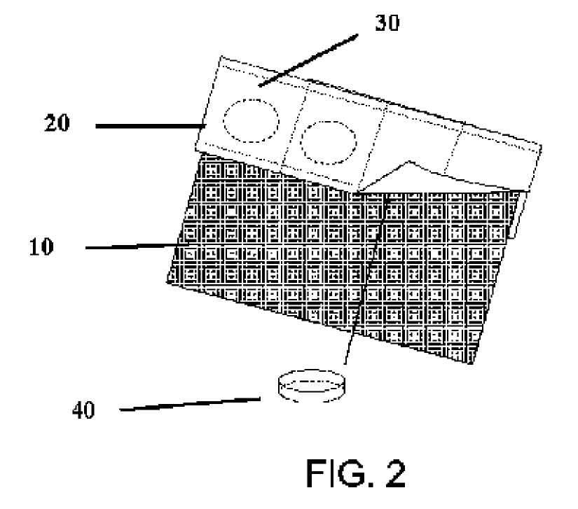

The frame 20 is attached to the netting 10 in a way that magnet pockets 30 are formed. These magnet pockets 30 are evenly spaced at equal distances throughout the frame 20. Into theses magnet pockets 30, a ¾ inch or ⅝ inch craft magnet 40 are inserted as shown in FIG. 2. The magnet pockets 30 are closed using a closing means such as being sewn so as to encase each magnet 40 in a separate pocket 30 isolating it to its specific area in the frame.

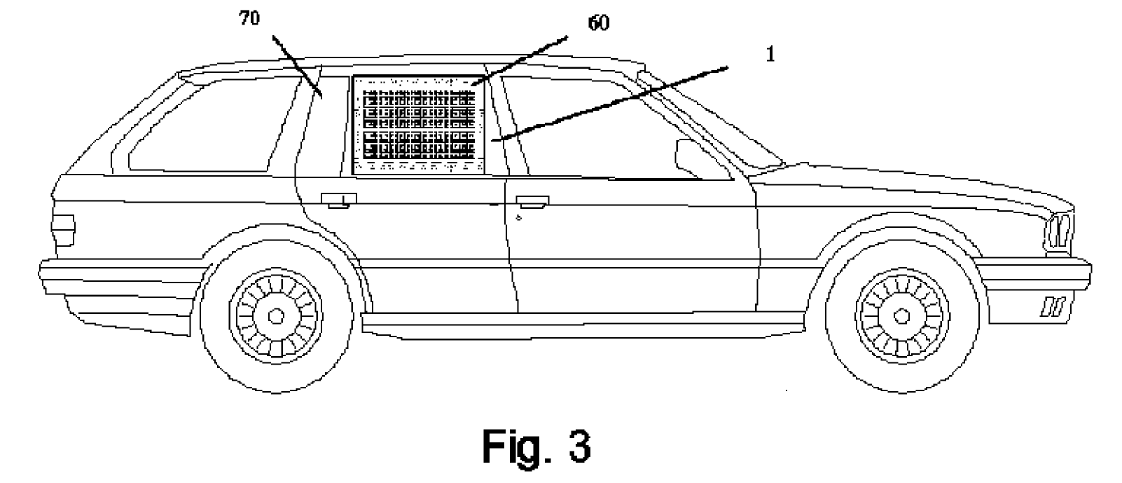

The screen assembly 1 can be created to match any automobile passenger window size, is then placed over the exterior of the automobile window 60. The magnets 40 adhere to the vehicle as shown in FIG. 3 creating a bug-proof barrier. The magnets 40 are attached to the automobile body 70 through the magnetic pull of the magnet 40.

The screen assembly 1 is rectangular in shape. The netting 10 will stop bugs and other objects from getting into the vehicle but will allow ventilation while the vehicle is at rest either parking of camping.

The screen assembly 1 will be made out of a flexible material such as cloth and mosquito netting so that it can be folded and put away when it is not being used The screen assembly 1 is designed to be easy to use and place on the windshield when needed and easy to take off when not in use. The use of the magnets 40 to attach the screen assembly 1 to the automobile 70 allows the screen assembly 1 to be firmly attached to said automobile 70 while allowing ease in removal. The magnets 40 are contained with the pocket 30 which are covered with a soft cloth material in the preferred embodiment. This material helps to prevent any scrapping or scuffing on the automobile 40 by the screen assembly 1.

Although many features, functions, and advantages of the present invention have been described in this specification, together with details of the structure of specific embodiments thereof, the description as a whole is illustrative only, and substitutions may be made in detail, especially in matters of shape, dimension and arrangement of elements within the principles of the invention to the full extent indicated by the broad, general meaning of the terms in which the claims are expressed. Therefore, the point and scope of the appended claims should not be limited to the description of the preferred versions contained herein.

That which is claimed is:

1. A bug screen comprising;
a net with a plurality of magnets.

2. The bug screen as in claim 1, wherein said net is within a frame.

3. The bug screen as in claim 2, wherein said magnets are evenly spaced around said frame.

4. The bug screen as in claim 2, wherein said frame is attached to said net through an attaching means.

5. The bug screen as in claim 4, wherein said attachment means is sewing.

6. The bug screen as in claim 3, where said magnets are stored in pockets in said frame.

7. The bug screen as in claim 6, wherein said pockets are evenly spaced in said frame.

8. The bug screen as in claim 6, wherein said magnets are free to move in said pockets.

9. The bug screen as in claim 2, wherein said frame is 1½ inches wide.

10. The bug screen as in claim 1 wherein said screen is attached to an automobile covering the windshield of said automobile.

11. The bug screen as in claim 10, where said screen is attached to said automobile by the magnetic pull of the magnets.

12. A bug screen comprising; a screen with a plurality of magnets where said net is within a frame and said magnets are contained in pockets that evenly spaced around said frame.

13. The bug screen as in claim 12, wherein said frame is attached to said net through an attaching means.

14. The bug screen as in claim 13, wherein said attachment means is sewing.

15. The bug screen as in claim 12, wherein said magnets are free to move in said pockets.

16. The bug screen as in claim 12, wherein said frame is 1½ inches wide.

17. The bug screen as in claim 1 2 wherein said screen is attached to an automobile covering the windshield of said automobile.

18. The bug screen as in claim 1 7, where said screen is attached to said automobile by the magnetic pull of the magnets.

19. A bug screen comprising;
a screen with a plurality of magnets where said net is within a frame and said magnets are contained in pockets that evenly spaced around said frame wherein said screen is attached to an automobile covering the windshield of said automobile, where said screen is attached to said automobile by the magnetic pull of the magnets.

20. The bug screen as in claim 1 9, wherein said magnets are free to move in said pockets.
